(19) United States
(12) Patent Application Publication
(10) Pub. No.: US 2020/0184994 A1
(43) Pub. Date: Jun. 11, 2020

(54) SYSTEM AND METHOD FOR ACOUSTIC LOCALIZATION OF MULTIPLE SOURCES USING SPATIAL PRE-FILTERING

(71) Applicant: Nuance Communications, Inc., Burlington, MA (US)

(72) Inventors: Tobias Wolff, Neu-Ulm Burlafingen (DE); Simon Graf, Ulm (DE); Timo Matheja, Neu-Ulm (DE)

(21) Appl. No.: 16/213,254

(22) Filed: Dec. 7, 2018

(51) Int. Cl. G10L 25/78; G10L 15/22; G10L 15/02; G10L 15/30

(52) U.S. Cl. CPC G10L 25/78; G10L 15/30; G10L 15/02; G10L 15/22

(57) ABSTRACT

A method, computer program product, and computer system for identifying, by a computing device, a plurality of sources, wherein a first source of the plurality of sources is a source of interest and wherein a second source of the plurality of sources is an interference source. The first source and the second source may be monitored simultaneously by implementing a spatial pre-filter for acoustic source localization.

### BACKGROUND

Automated speech recognition (ASR) may be used for many different things. For example, smart speakers and Internet of Things (IoT) devices may employ ASR. For smart speakers, a challenging test condition may be that a Wake-up-Word (WuW) may need to be detected and localized (e.g., in terms of azimuth angle) in the presence of strong directional interferers such as a TV. For known systems, the WuW may generally only be detected and localized if it is not masked by the interferer. In certain situations, e.g., in low speech intelligibility rating situations such as in the presence of directional interferers like a TV, the WuW may be missed by known multisource acoustic source locators.

### BRIEF SUMMARY OF DISCLOSURE

In one example implementation, a method, performed by one or more computing devices, may include but is not limited to identifying, by a computing device, a plurality of sources, wherein a first source of the plurality of sources is a source of interest and wherein a second source of the plurality of sources is an interference source. The first source and the second source may be monitored simultaneously by implementing a spatial pre-filter for acoustic source localization.

One or more of the following example features may be included. The pre-filtering may be based upon, at least in part, Multichannel Coherent to Diffuse Ratio. Sound may be excluded from an a-priori known steering angle of the spatial pre-filter from a localization of one of the first source and the second source. A steering angle of the spatial pre-filter may be determined based upon, at least in part, one of a-priori knowledge and an external sensor. A steering angle of the spatial pre-filter may be determined based upon, at least in part, a localization result from a last processing frame. Each detected source of the plurality of sources may have a dedicated spatial pre-filter of a bank of spatial pre-filters. A further spatial pre-filter associated with background may be determined to reduce masking artifacts and enable localization of one or more previously masked sources. An expectation step may be carried out in a postprocessor using one or more broadband raw acoustic source localization results. Spatial pre-filtering may be used as a replacement for an expectation step in an expectation maximization based classifier. The spatial pre-filter may be combined with one or more non-spatial filters.

In another example implementation, a computing system may include one or more processors and one or more memories configured to perform operations that may include but are not limited to identifying a plurality of sources, wherein a first source of the plurality of sources is a source of interest and wherein a second source of the plurality of sources is an interference source. The first source and the second source may be monitored simultaneously by implementing a spatial pre-filter for acoustic source localization.

One or more of the following example features may be included. The pre-filtering may be based upon, at least in part, Multichannel Coherent to Diffuse Ratio. Sound may be excluded from an a-priori known steering angle of the spatial pre-filter from a localization of one of the first source and the second source. A steering angle of the spatial pre-filter may be determined based upon, at least in part, one of a-priori knowledge and an external sensor. A steering angle of the spatial pre-filter may be determined based upon, at least in part, a localization result from a last processing frame. Each detected source of the plurality of sources may have a dedicated spatial pre-filter of a bank of spatial pre-filters. A further spatial pre-filter associated with background may be determined to reduce masking artifacts and enable localization of one or more previously masked sources. An expectation step may be carried out in a postprocessor using one or more broadband raw acoustic source localization results. Spatial pre-filtering may be used as a replacement for an expectation step in an expectation maximization based classifier. The spatial pre-filter may be combined with one or more non-spatial filters.

In another example implementation, a computer program product may reside on a computer readable storage medium having a plurality of instructions stored thereon which, when executed across one or more processors, may cause at least a portion of the one or more processors to perform operations that may include but are not limited to identifying a plurality of sources, wherein a first source of the plurality of sources is a source of interest and wherein a second source of the plurality of sources is an interference source. The first source and the second source may be monitored simultaneously by implementing a spatial pre-filter for acoustic source localization.

One or more of the following example features may be included. The pre-filtering may be based upon, at least in part, Multichannel Coherent to Diffuse Ratio. Sound may be excluded from an a-priori known steering angle of the spatial pre-filter from a localization of one of the first source and the second source. A steering angle of the spatial pre-filter may be determined based upon, at least in part, one of a-priori knowledge and an external sensor. A steering angle of the spatial pre-filter may be determined based upon, at least in part, a localization result from a last processing frame. Each detected source of the plurality of sources may have a dedicated spatial pre-filter of a bank of spatial pre-filters. A further spatial pre-filter associated with background may be determined to reduce masking artifacts and enable localization of one or more previously masked sources. An expectation step may be carried out in a postprocessor using one or more broadband raw acoustic source localization results. Spatial pre-filtering may be used as a replacement for an expectation step in an expectation maximization based classifier. The spatial pre-filter may be combined with one or more non-spatial filters.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of an acoustic source localization (ASL) process coupled to an example distributed computing network according to one or more example implementations of the disclosure;

FIG. 2 is an example diagrammatic view of a computer and client electronic device of FIG. 1 according to one or more example implementations of the disclosure;

FIG. 3 is an example flowchart of a ASL process according to one or more example implementations of the disclosure;

FIG. 4 is an example diagrammatic view of an example structure that may be used by ASL process according to one or more example implementations of the disclosure;

FIG. 5 is an example Frequency Selective Angular Spectrum for Delay and Sum Beamforming chart according to one or more example implementations of the disclosure;

FIG. 6 is an example diagrammatic view of an broadband localizer and localization with EM-Based classifier that may be used by ASL process according to one or more example implementations of the disclosure;

FIG. 7 is an example diagrammatic view of an example environment that may be used by ASL process according to one or more example implementations of the disclosure;

FIG. 8 is an example diagrammatic view of an example broadband localizer using a spatial pre-filter and an example broadband localizer where the pre-filter steering angle is determined by a-priori knowledge and/or information from external sensors that may be used by ASL process according to one or more example implementations of the disclosure;

FIG. 9 is an example diagrammatic view of an example structure that may be used by ASL process according to one or more example implementations of the disclosure;

FIG. 10 is an example chart showing wake-up-word detection due to masking and due to pre-filtering according to one or more example implementations of the disclosure; and

FIG. 11 is an example chart showing wake-up-word detection due to masking and due to pre-filtering according to one or more example implementations of the disclosure.

Like reference symbols in the various drawings indicate like elements.

### DETAILED DESCRIPTION

### System Overview:

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

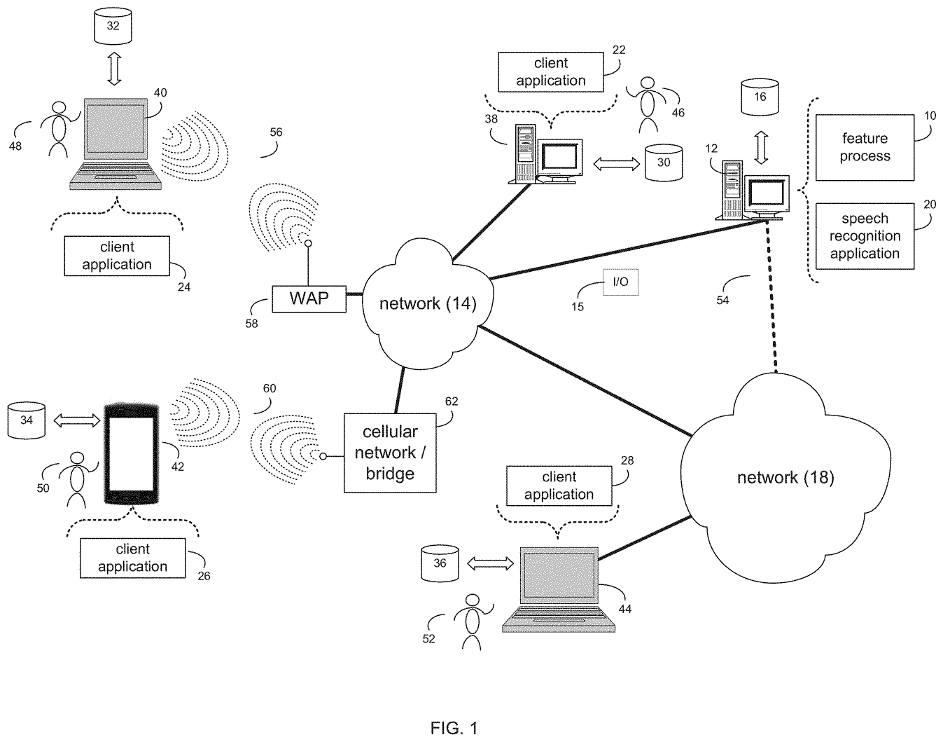

Referring now to the example implementation of FIG. 1, there is shown ASL process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). As is known in the art, a SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, an acoustic source localization (ASL) process, such as ASL process 10 of FIG. 1, may identify, by a computing device, a plurality of sources, wherein a first source of the plurality of sources is a source of interest and wherein a second source of the plurality of sources is an interference source. The first source and the second source may be monitored simultaneously by implementing a spatial pre-filter for acoustic source localization.

In some implementations, the instruction sets and subroutines of ASL process 10, which may be stored on storage device, such as storage device 16, coupled to computer 12, may be executed by one or more processors and one or more memory architectures included within computer 12. In some implementations, storage device 16 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 16 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 14 may be connected to one or more secondary networks (e.g., network 18), examples of which may include but are not limited to: a local area network; a wide area network or other telecommunications network facility; or an intranet, for example. The phrase “telecommunications network facility,” as used herein, may refer to a facility configured to transmit, and/or receive transmissions to/from one or more mobile client electronic devices (e.g., cellphones, etc.) as well as many others.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, ASL process 10 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute an automatic speech recognition (ASR) application (e.g., speech recognition application 20), examples of which may include, but are not limited to, e.g., an automatic speech recognition (ASR) application (e.g., modeling, etc.), a natural language understanding (NLU) application (e.g., machine learning, intent discovery, etc.), a text to speech (TTS) application (e.g., context awareness, learning, etc.), a speech signal enhancement (SSE) application (e.g., multi-zone processing/beamforming, noise suppression, etc.), a voice biometrics/wake-up-word processing application, a video conferencing application, a voice-over-IP application, a video-over-IP application, an Instant Messaging (IM)/“chat” application, a short messaging service (SMS)/multimedia messaging service (MMS) application, or other application that allows for virtual meeting and/or remote collaboration and/or recognition/translation of spoken language into text by computing devices.

In some implementations, ASL process 10 and/or speech recognition application 20 may be accessed via one or more of client applications 22, 24, 26, 28. In some implementations, ASL process 10 may be a standalone application, or may be an applet/application/script/extension that may interact with and/or be executed within speech recognition application 20, a component of speech recognition application 20, and/or one or more of client applications 22, 24, 26, 28. In some implementations, speech recognition application 20 may be a standalone application, or may be an applet/application/script/extension that may interact with and/or be executed within ASL process 10, a component of ASL process 10, and/or one or more of client applications 22, 24, 26, 28. In some implementations, one or more of client applications 22, 24, 26, 28 may be a standalone application, or may be an applet/application/script/extension that may interact with and/or be executed within and/or be a component of ASL process 10 and/or speech recognition application 20. Examples of client applications 22, 24, 26, 28 may include, but are not limited to, e.g., an automatic speech recognition (ASR) application (e.g., modeling, etc.), a natural language understanding (NLU) application (e.g., machine learning, intent discovery, etc.), a text to speech (TTS) application (e.g., context awareness, learning, etc.), a speech signal enhancement (SSE) application (e.g., multi-zone processing/beamforming, noise suppression, etc.), a voice biometrics/wake-up-word processing application, a video conferencing application, a voice-over-IP application, a video-over-IP application, an Instant Messaging (IM)/“chat” application, a short messaging service (SMS)/multimedia messaging service (MMS) application, or other application that allows for virtual meeting and/or remote collaboration and/or recognition/translation of spoken language into text by computing devices, a standard and/or mobile web browser, an email application (e.g., an email client application), a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors and one or more memory architectures incorporated into client electronic devices 38, 40, 42, 44, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet, a server, a television, a smart television, a smart speaker, an Internet of Things (IoT) device, a media (e.g., video, photo, etc.) capturing device, and a dedicated network device. Client electronic devices 38, 40, 42, 44 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 22, 24, 26, 28 may be configured to effectuate some or all of the functionality of ASL process 10 (and vice versa). Accordingly, in some implementations, ASL process 10 may be a purely server-side application, a purely client-side application, or a hybrid server-side/client-side application that is cooperatively executed by one or more of client applications 22, 24, 26, 28 and/or ASL process 10.

In some implementations, one or more of client applications 22, 24, 26, 28 may be configured to effectuate some or all of the functionality of speech recognition application 20 (and vice versa). Accordingly, in some implementations, speech recognition application 20 may be a purely server-side application, a purely client-side application, or a hybrid server-side/client-side application that is cooperatively executed by one or more of client applications 22, 24, 26, 28 and/or speech recognition application 20. As one or more of client applications 22, 24, 26, 28, ASL process 10, and speech recognition application 20, taken singly or in any combination, may effectuate some or all of the same functionality, any description of effectuating such functionality via one or more of client applications 22, 24, 26, 28, ASL process 10, speech recognition application 20, or combination thereof, and any described interaction(s) between one or more of client applications 22, 24, 26, 28, ASL process 10, speech recognition application 20, or combination thereof to effectuate such functionality, should be taken as an example only and not to limit the scope of the disclosure.

In some implementations, one or more of users 46, 48, 50, 52 may access computer 12 and ASL process 10 (e.g., using one or more of client electronic devices 38, 40, 42, 44) directly through network 14 or through secondary network 18. Further, computer 12 may be connected to network 14 through secondary network 18, as illustrated with phantom link line 54. ASL process 10 may include one or more user interfaces, such as browsers and textual or graphical user interfaces, through which users 46, 48, 50, 52 may access ASL process 10.

In some implementations, the various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, 802.11n, 802.11ac, Wi-Fi®, RFID, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown by example directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

In some implementations, various I/O requests (e.g., I/O request 15) may be sent from, e.g., client applications 22, 24, 26, 28 to, e.g., computer 12. Examples of I/O request 15 may include but are not limited to, data write requests (e.g., a request that content be written to computer 12) and data read requests (e.g., a request that content be read from computer 12).

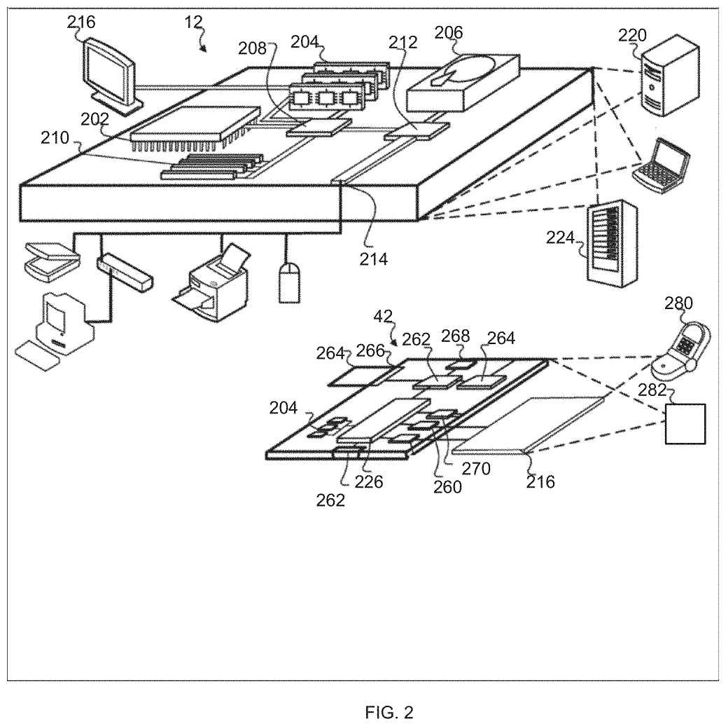

Referring also to the example implementation of FIG. 2, there is shown a diagrammatic view of computer 12 and client electronic device 42. While client electronic device 42 and computer 12 are shown in this figure, this is for example purposes only and is not intended to be a limitation of this disclosure, as other configurations are possible. Additionally, any computing device capable of executing, in whole or in part, ASL process 10 may be substituted for client electronic device 42 and computer 12 (in whole or in part) within FIG. 2, examples of which may include but are not limited to one or more of client electronic devices 38, 40, and 44. Client electronic device 42 and/or computer 12 may also include other devices, such as televisions with one or more processors embedded therein or attached thereto as well as any of the microphones, microphone arrays, and/or speakers described herein. The components shown here, their connections and relationships, and their functions, are meant to be examples only, and are not meant to limit implementations of the disclosure described.

In some implementations, computer 12 may include processor 202, memory 204, storage device 206, a high-speed interface 208 connecting to memory 204 and high-speed expansion ports 210, and low speed interface 212 connecting to low speed bus 214 and storage device 206. Each of the components 202, 204, 206, 208, 210, and 212, may be interconnected using various busses, and may be mounted on a common motherboard or in other manners as appropriate. The processor 202 can process instructions for execution within the computer 12, including instructions stored in the memory 204 or on the storage device 206 to display graphical information for a GUI on an external input/output device, such as display 216 coupled to high speed interface 208. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

Memory 204 may store information within the computer 12. In one implementation, memory 204 may be a volatile memory unit or units. In another implementation, memory 204 may be a non-volatile memory unit or units. The memory 204 may also be another form of computer-readable medium, such as a magnetic or optical disk.

Storage device 206 may be capable of providing mass storage for computer 12. In one implementation, the storage device 206 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 204, the storage device 206, memory on processor 202, or a propagated signal.

High speed controller 208 may manage bandwidth-intensive operations for computer 12, while the low speed controller 212 may manage lower bandwidth-intensive operations. Such allocation of functions is exemplary only. In one implementation, the high-speed controller 208 may be coupled to memory 204, display 216 (e.g., through a graphics processor or accelerator), and to high-speed expansion ports 210, which may accept various expansion cards (not shown). In the implementation, low-speed controller 212 is coupled to storage device 206 and low-speed expansion port 214. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

Computer 12 may be implemented in a number of different forms, as shown in the figure. For example, computer 12 may be implemented as a standard server 220, or multiple times in a group of such servers. It may also be implemented as part of a rack server system 224. Alternatively, components from computer 12 may be combined with other components in a mobile device (not shown), such as client electronic device 42. Each of such devices may contain one or more of computer 12, client electronic device 42, and an entire system may be made up of multiple computing devices communicating with each other.

Client electronic device 42 may include processor 226, memory 204, an input/output device such as display 216, a communication interface 262, and a transceiver 264, among other components. Client electronic device 42 may also be provided with a storage device, such as a microdrive or other device, to provide additional storage. Each of the components 226, 204, 216, 262, and 264, may be interconnected using various buses, and several of the components may be mounted on a common motherboard or in other manners as appropriate.

Processor 226 may execute instructions within client electronic device 42, including instructions stored in the memory 204. The processor may be implemented as a chipset of chips that include separate and multiple analog and digital processors. The processor may provide, for example, for coordination of the other components of client electronic device 42, such as control of user interfaces, applications run by client electronic device 42, and wireless communication by client electronic device 42.

In some embodiments, processor 226 may communicate with a user through control interface 258 and display interface 260 coupled to a display 216. The display 216 may be, for example, a TFT LCD (Thin-Film-Transistor Liquid Crystal Display) or an OLED (Organic Light Emitting Diode) display, or other appropriate display technology. The display interface 260 may comprise appropriate circuitry for driving the display 216 to present graphical and other information to a user. The control interface 258 may receive commands from a user and convert them for submission to the processor 226. In addition, an external interface 262 may be provide in communication with processor 226, so as to enable near area communication of client electronic device 42 with other devices. External interface 262 may provide, for example, for wired communication in some implementations, or for wireless communication in other implementations, and multiple interfaces may also be used.

In some embodiments, memory 204 may store information within the Client electronic device 42. The memory 204 can be implemented as one or more of a computer-readable medium or media, a volatile memory unit or units, or a non-volatile memory unit or units. Expansion memory 264 may also be provided and connected to client electronic device 42 through expansion interface 266, which may include, for example, a SIMM (Single In Line Memory Module) card interface. Such expansion memory 264 may provide extra storage space for client electronic device 42, or may also store applications or other information for client electronic device 42. Specifically, expansion memory 264 may include instructions to carry out or supplement the processes described above, and may include secure information also. Thus, for example, expansion memory 264 may be provide as a security module for client electronic device 42, and may be programmed with instructions that permit secure use of client electronic device 42. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product may contain instructions that, when executed, perform one or more methods, such as those described above. The information carrier may be a computer- or machine-readable medium, such as the memory 204, expansion memory 264, memory on processor 226, or a propagated signal that may be received, for example, over transceiver 264 or external interface 262.

Client electronic device 42 may communicate wirelessly through communication interface 262, which may include digital signal processing circuitry where necessary. Communication interface 262 may provide for communications under various modes or protocols, such as GSM voice calls, SMS, EMS, or MMS speech recognition, CDMA, TDMA, PDC, WCDMA, CDMA2000, or GPRS, among others. Such communication may occur, for example, through radio-frequency transceiver 264. In addition, short-range communication may occur, such as using a Bluetooth, WiFi, or other such transceiver (not shown). In addition, GPS (Global Positioning System) receiver module 268 may provide additional navigation and location-related wireless data to client electronic device 42, which may be used as appropriate by applications running on client electronic device 42.

Client electronic device 42 may also communicate audibly using audio codec 270, which may receive spoken information from a user and convert it to usable digital information. Audio codec 270 may likewise generate audible sound for a user, such as through a speaker, e.g., in a handset of client electronic device 42. Such sound may include sound from voice telephone calls, may include recorded sound (e.g., voice messages, music files, etc.) and may also include sound generated by applications operating on client electronic device 42. Client electronic device 42 may be implemented in a number of different forms, as shown in the figure. For example, it may be implemented as a cellular telephone 280. It may also be implemented as part of a smartphone 282, personal digital assistant, remote control, or other similar mobile device.

As discussed above, automated speech recognition (ASR) may be used for many different things. For example, smart speakers and Internet of Things (IoT) devices may employ ASR. Automated speech recognition (ASR) may be used for many different things. For example, smart speakers and Internet of Things (IoT) devices may employ ASR. For smart speakers, a challenging test condition may be that a Wake-up-Word (WuW) may need to be detected and localized (e.g., in terms of azimuth angle) in the presence of strong directional interferers such as a TV. For known systems, the WuW may generally only be detected and localized if it is not masked by the interferer. In certain situations, e.g., in the presence of directional interferers such as a TV, the WuW may be missed by known multisource acoustic source locators (ASL). One example reason for this is mostly the core ASL, which cannot differentiate sources in its broadband DOA estimate. Thus, the source classification algorithm is likely to miss the WuW.

Therefore, as will be discussed below, the present disclosure may make the acoustic localization more sensitive in this example situation, so the WuW may be detected better. In particular, the present disclosure may enable the estimation of the direction of arrival angle for several sources in the same time-frame. This may improve the ability of SSE to capture and localize WuWs in the presence of strong interferers.

As will be discussed below, ASL process 10 may at least help, e.g., improve beam steering technology necessarily rooted in computer technology in order to overcome an example and non-limiting problem specifically arising in the realm of automated speech recognition associated with, e.g., Wake-up-word (WuW) source detection and identification. It will be appreciated that the computer processes described throughout are not considered to be well-understood, routine, and conventional functions.
The Acoustic Source Localization (ASL) Process:

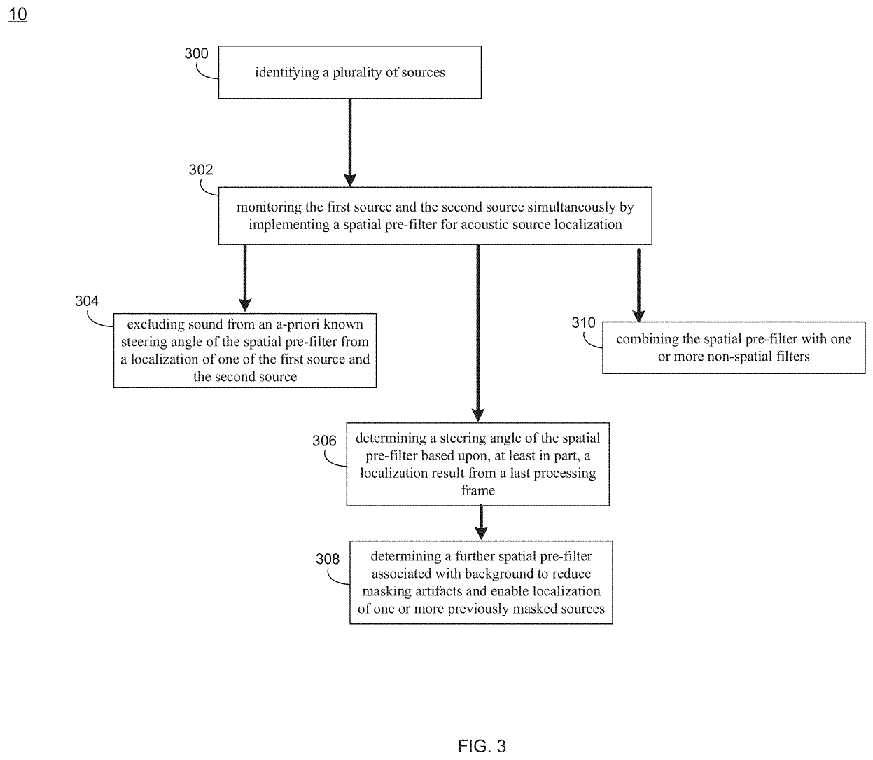

As discussed above and referring also at least to the example implementations of FIGS. 3-8, ASL process 10 may identify 300, by a computing device, a plurality of sources, wherein a first source of the plurality of sources is a source of interest and wherein a second source of the plurality of sources is an interference source. ASL process 10 may monitor 302 the first source and the second source simultaneously by implementing a spatial pre-filter for acoustic source localization.

The term “beamforming”, as used herein, may generally refer to a signal processing technique used in sensor arrays for directional signal transmission and/or reception. Beamforming methods may be used for background noise reduction in a variety of different applications. A beamformer, may be configured to process signals emanating from, e.g., a microphone array, to obtain a combined signal in such a way that signal components coming from a direction different from a predetermined wanted signal direction are suppressed. Microphone arrays, unlike conventional directional microphones, may be electronically steerable which gives them the ability to acquire a high-quality signal or signals from a desired direction or directions while attenuating off- axis noise or interference. It should be noted that the discussion of beamforming is provided merely by way of example as the teachings of the present disclosure may be used with any suitable signal processing method.

The present disclosure described herein may refer to the field of acoustic localization of sound sources (“Acoustic Source Localization” or ASL). In some implementations, an example benefit of the present disclosure may be to localize multiple sources simultaneously (e.g., within one processing frame). It may generally be assumed that there is one dominant source in each frequency band. The proposed example technique may improve the simultaneous localization of sources that are distinct in terms of their spectra, while at the same time providing robustness with respect to spatial aliasing.

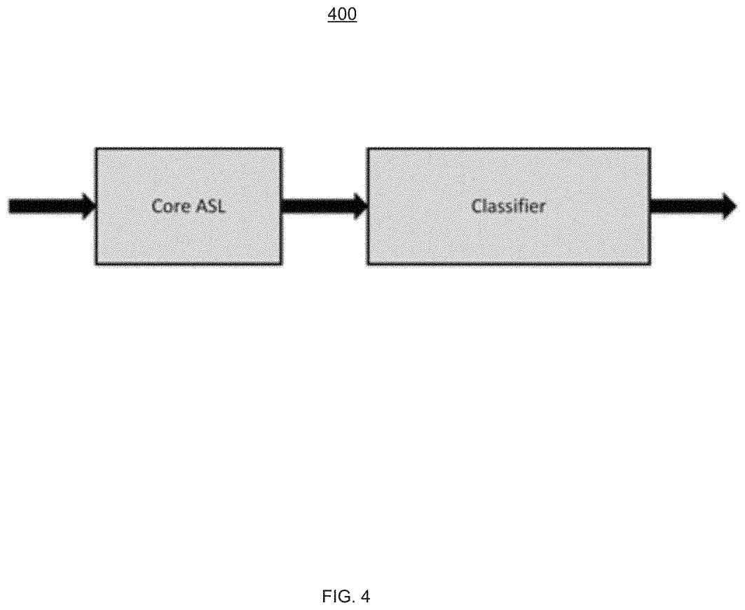

In some implementations, and referring at least to FIG. 4, an example known structure 400 that may be used by other source localizers is shown; however, the present disclosure is not limited to these structures. In the example, structure 400 may include a core-localization (or localization core) followed by a classifier. Generally, the core localizer may provide (noisy) raw localization data (e.g., angles), and the classifier may assign those data into different classes (e.g., sources) and may estimate their angle e.g., by averaging In some implementations, where the estimates are sent to may depend on the application. For example, the estimates may be sent to the steering control of a beamformer, but also to control cameras or robot movement, etc. Previous techniques may use, for example, a broadband core-localizer, which may provide only one single raw Direction of Arrival (DOA) estimate of one source at a time. The advantage is that spatial ambiguities (spatial aliasing) are not a big problem here due to the broadband nature. The disadvantage, however, is that whenever multiple sources are active simultaneously, they mask each other even if they cover different frequency regions.

Among several techniques for acoustic source localization may be the Steered Response Power (SRP) method, which is used as an example only for reference. The SRP may process (e.g., via ASL process 10) the signals from a microphone array by applying beamforming in a variety of angles. For example, a 5° grid may be chosen to scan the azimuth plane. For each beamformer w(ω, φ) the output power may be obtained (for a given beamformer steering angle φ):

Y(ω, φ)=w^{H}(ω, φ)Φₓₓ(ω)w(ω, φ)

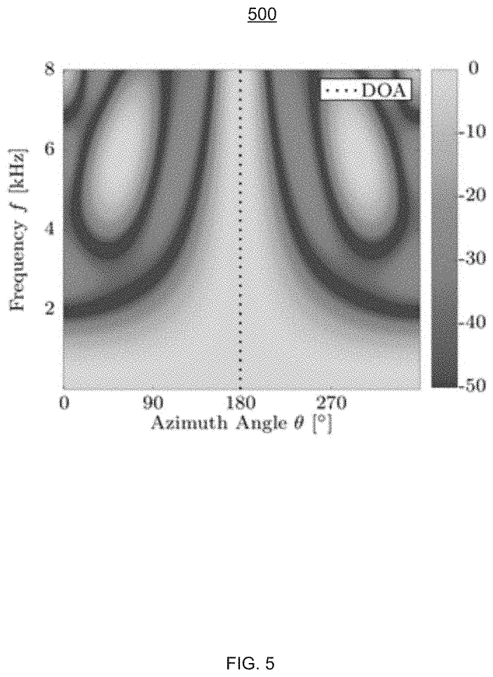

Here, Φₓₓ(ω) is the covariance matrix of the M microphone signals x_{M}(ω), m∈[0:M−1] at the considered (normalized) frequency ω. The above equation describes a two-dimensional function Y(ω, φ) in frequency ω and angle φ which is referred to here as “angular spectrum”. For each frequency w this angular spectrum may exhibit a peak at the angle of the sound source (see the example Frequency Selective Angular Spectrum for Delay and Sum Beamforming chart 500 in FIG. 5). In FIG. 5, the DOA of the sound source is 180°. At ˜6 kHz sidelobes may be observed due to spatial aliasing. The position of the maximum may therefore be used as an estimate for the sources' DOA:

\hat{φ}(ω)=ar gmax(Y(ω, φ))

Hence, for each frequency ω an estimate \hat{φ} is obtained (angle φ that maximizes Y(ω, φ)). This is an example of a spectral ASL method. Spectral methods have a great advantage that sources which cover different frequency bands may be observed at the same time. This holds even if the used core-localizer can only resolve one source per frequency and time frame. Some core-localizers may resolve more than one source directly, which is computationally expensive and typically not robust to room acoustics. The example drawback of spectral ASL may be that those methods are sensitive to spatial aliasing. Spatial aliasing may occur if the microphone spacing is smaller than half the wavelength at the considered frequency. The effect is that there will be a second peak in the angular spectrum that does not correspond to an actual source. It is therefore then unknown which peak represents the actual source and which is the alias. Consequently, “ghost-sources” may appear. This effect may limit the practical usage of such localizers because either the bandwidth or the array size must be constrained in order to avoid aliasing.

A practical alternative to spectral ASL may be broadband ASL. Here, the spectral angular spectrum is integrated along frequency so as to obtain the broadband angular spectrum:

$${Y}_{b} ( ϕ ) = \frac{1}{2 π} {\int }_{0}^{2 π} Y ( ω , ϕ ) d ω$$

Clearly, this is no longer a function of but only of A maximum search results in the respective broadband DOA estimate. As can be seen from FIG. 5, the aliasing frequencies all correspond to different angles (wavelength dependency of spatial aliasing). Therefore, the integration averages out this effect and introduces robustness. Broadband ASL is therefore robust with respect to spatial aliasing. However, it generally cannot differentiate multiple sources even if they are spectrally disjoint. Rather, the opposite is true: the spectral averaging (integral) sums up all observations which makes the sources mask each other. Consequently, the peak(s) in the angular spectrum are less pronounced because each source interferes with the other source. While aliasing robustness is desirable, masking is clearly undesired. Practically the masking effect degrades the ability to detect sources in the presence of an interfering source.

In addition to what has been described so far, an example technique may be to introduce a filter F(ω) in above equation to sharpen the peak in Y_{b}(φ) e.g. for colored signals:

$${Y}_{b} ( ϕ ) = \frac{1}{2 π} {\int }_{0}^{2 π} Y ( ω , ϕ ) d ω$$

The most prominent filter being

$$F ( ω ) = \frac{1}{{φ}_{xx} ( ω )}$$

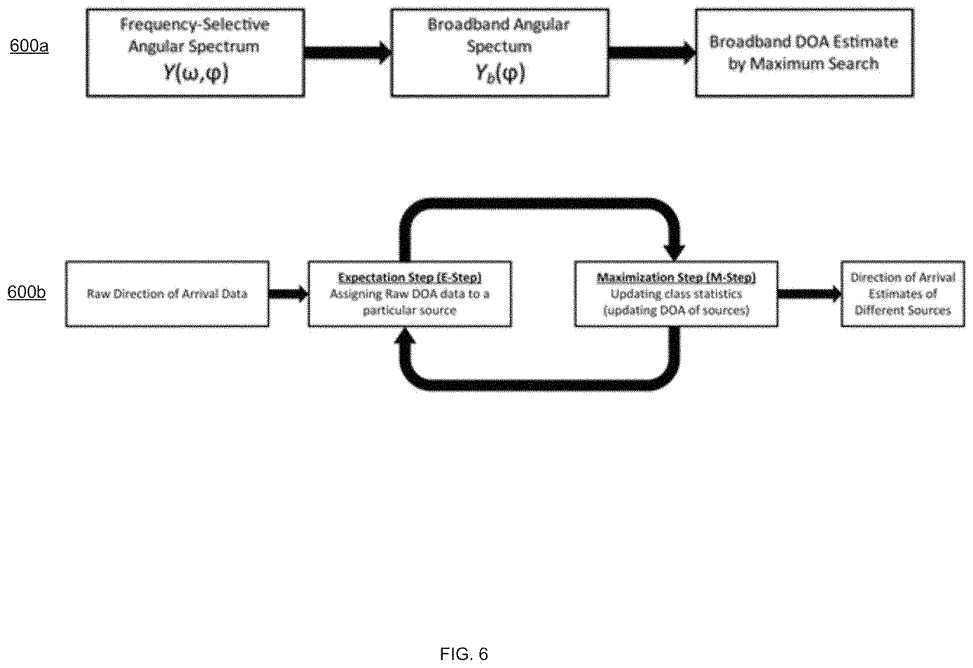

which introduces a normalization of each frequency to 1 (whitening) in order to remove the coloration and obtain a corresponding sharp peak in Y_{b}(φ) . This is referred to as the “Phase Transform” or “PHAT” normalization. Note that the given form of the PHAT normalization generally only holds if all microphones truly have the same power spectral density. Otherwise, it takes a somewhat different form. Also, noise reduction filters are typically applied here. However, typically, the filters used here do not carry or exploit any spatial information yet, and only power information is considered. Referring at least to FIG. 6, an example block diagram of a broadband localizer 600a is shown.

The methods described above generally provide either spectral or broadband localization data per time frame. This may be a single DOA value per frame or even an entire vector of spectral DOA values. Those data are generally noisy and cannot be used directly. Therefore, a postprocessor is usually employed to obtain DOA estimates with little variance for final usage. Such post-processing may be implemented using the Expectation-Maximization (EM) Principle which generally consists of two steps. For instance, a block diagram for localization with EM-Based classifier 600b is shown in FIG. 6. During the Expectation step (Expectation or E-step) the new data is interpreted in terms of the statistics learned during the previous iterations. Here, this means that the DOA values are associated with any possible class (e.g., source). For example, if a DOA of 76° is being observed, this observation is likely to stem from the source which used to be located at 75° in the last iteration. In a second step (Maximization or M-Step) the class statistics (here the DOAs for each source) are changed such that their likelihood is maximized given the assignment during the E-step was correct. Practically, this means that a new average DOA across the current observation window is computed.

It may be beneficial to note that an important point in the context of the present disclosure may be that the classifier generally first figures out which source the raw observations belongs to, so their DOA estimate may be improved, corrected or updated respectively. This should be kept in mind. In principle, however, the postprocessing may also done differently. In some implementations, one or more parts of the present disclosure may assume that there is a post-processed result for multiple sources available.

In some implementations, the present disclosure may generally be described as a unique approach that is in between the broadband core localizer and spectral localization approaches. For example, ASL process 10 may exploit the spectral differences while still estimating the DOA in the broadband domain. The broadband DOA estimate may be robust with respect to aliasing by nature, while masking effects may be counteracted by pre-filtering the observed data before updating the DOA estimate of a source. While a standard broadband core localizer generally only sees the dominant source and hence either forgets about the masked source or misses the desired source, the present disclosure implements one or more techniques that may uniquely enable monitoring both (desired and masked/interference source(s)) simultaneously.

Generally, the ability to monitor two (or more) sources simultaneously may be beneficial for successfully applying SSE for, e.g., smart speakers or other IoT devices. Here, speech enhancement algorithms of ASL process 10 have to cope with strong directional interferes such as, e.g., a TV, a radio playing in the kitchen, and so on. Since beamforming generally relies on correct localization of the speech source, it may be beneficial for the localizer to have the capability of finding the DOA of the target signal, even if it is masked by the interferer. As such, the present disclosure may improve the ability to find the DOA of a Wake-up-Word (WuW) in the presence of strong interference, may reduce masking of sources leading to higher sensitivity with respect to detecting low energy sources, and may be more robust with respect to spatial aliasing.

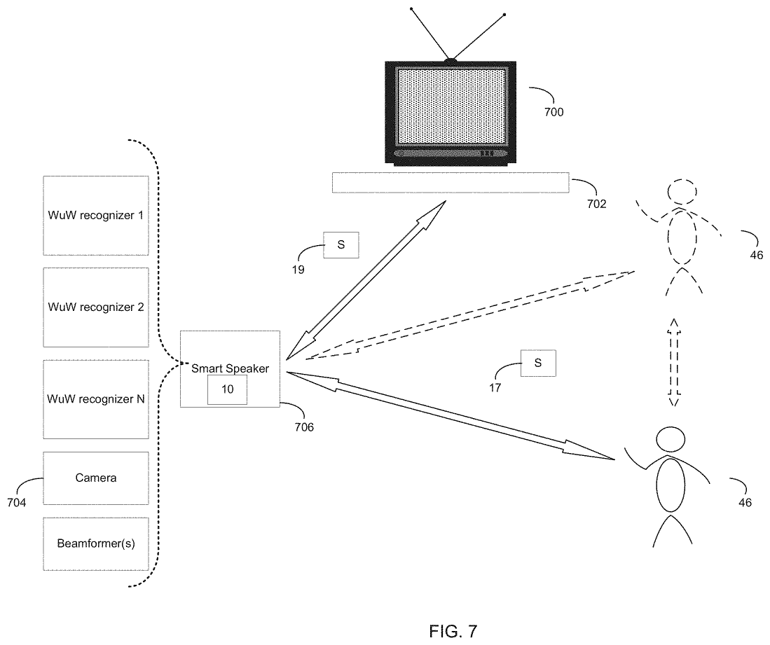

As will be discussed in greater detail below, in some implementations, ASL process 10 may identify 300 a plurality of sources, wherein a first source of the plurality of sources is a source of interest and wherein a second source of the plurality of sources is an interference source, and in some implementations, ASL process 10 may monitor 302 the first source and the second source simultaneously by implementing a spatial pre-filter for acoustic source localization. For example, in some implementations, and referring at least to the example implementation of FIG. 7, ASL process 10 may receive a first signal (e.g., signal 17) emitted from one or more sources (e.g., audio/acoustic source, such as user 46), and ASL process 10 may receive a second signal (e.g., signal 19) emitted from the one or more sources (e.g., audio/acoustic source, such as TV speaker 702), as well as various signals received from other sources. It will be appreciated that the one or more sources associated with the first signal and the one or more sources associated with the second signal may be the same sources, different sources, or combinations thereof (e.g., first source +second source =first signal, or second source +third source =second signal, etc.). The sources may emit their respective signals that may be recorded by one or more microphones (such as a microphone array of more than two microphones). The microphone signals may be processed, for example, with acoustic sources being spatially localized and tracked, and with the respective output signals being generated such that the different sources may be separated in the signals. On the one hand, the first signal may contain portions of another source (e.g., second, third, etc.). On the other hand, a first source may also be contained in the second signal. Thus, as will be discussed more below, if a WuW is detected in either signal, ASL process 10 may have the goal to determine which source was actually responsible for the WuW. In some implementations, ASL process 10 may focus on two (or more) selected sources to extract their respective received signals. For instance, each of the two respective output signals may be used for WuW spotting and the relative confidence of the two WuW recognizers may be determined to decide which of the two (or more) present sound sources cannot participate in a dialogue phase. As an example, ASL process 10 may be based on a multisource localization algorithm. This may provide information about the number of sources, their location, as well as activity information (e.g., a sound source may currently be silent or not). Based on this information, at least one beamformer may be controlled by ASL process 10 in the sense that its steering angle may be determined. During the WuW spotting phase, the beams may jump towards every sound source that is detected as a new source. Generally, the beam that is closest to that source may take it. This essentially makes ASL process 10 listen into all possible directions. However, ASL process 10 may also monitor whether a source is moving or not, and/or how active the source is. Once a source is found that has been active for some time (e.g., a threshold time of 1 second) and is additionally not moving, one beam may be set aside for that source, which may from then on continue to capture that source. The source may be, e.g., a TV (e.g., TV 700) or TV speaker (e.g., wireless TV speaker 702), but may also be a speaking person (e.g., user 46) that may possibly utter the WuW. In both cases, SP 10 may initially consider each source as a source of interest.

In some implementations, movement of the first source may be tracked with at least one of one or more core localizers (e.g., beamformer(s) and/or a camera). For instance, while one or more implementations may use one or more beamformers (e.g., within smart speaker 706) to track movement of the first source (e.g., user 46), it will be appreciated that a camera (e.g., camera 704) or other sensors may also be used by ASL process 10 to track movement of one or more sources. For instance, core localizers of sources (via ASL process 10) may also not only use acoustic methods (like “steered response power,” “generalized cross correlation” (GCC) or “multi-signal classification” (MUSIC)), but other methods like visual information gained via cameras may be exploited to localize sources (singly or in combination).

Thus, ASL process 10 may use multisource localization to control the beamformer(s) in order to separate two or more sound sources (provided in two or more output signals), and may use multisource localization to detect active sources that do not move. This means that ASL process 10 may consider active sources that are not moving as a source of interest. ASL process 10 may also thus control at least one of the beamformers such as to capture this “active static” source, and control another beamformer to capture any other source. As a result, ASL process 10 may provide a multisource ASL based processing that provides a focus on one source deemed important (such as the TV) while any other possible source may be captured by another beam. This leads to a spatially open behavior, where the second beam does not focus on the source captured by the first but may on anything else. Thus, in the example, controlling two beams such that one excludes signals captured by the other beam not only the steering angle may be controlled, but also the signal components that are minimized by the beamforming. This means optimizing the separation performance, e.g., the first beam lets source A pass without distortion and cancels source B, where the second beam does the exact opposite, e.g., lets source B pass without distortion but cancels source A, which may be achieved, for example, using the “Linearly Constrained Minimum Variance Design” for the beams.

While only two sources are described in the examples, it will be appreciated that more than two sources may also be used with the present disclosure. As such, the use of only two sources should be taken as example only and not to limit the scope of the disclosure.

In some implementations, ASL process 10 may use a spatial filter Fᵣₚ(ω, φ₀) instead of an energy-based filter F(ω). The main property of a spatial filter may be that it takes high values (close to one) for a given frequency w if the input signals exhibit energy from a given DOA φ₀. Otherwise, its response approaches zero. This may allow for the spectral suppression of signal components based on their DOA. Consequently, the resulting angular spectrum

$${Y}_{sp} ( ϕ ) = \frac{1}{2 π} {\int }_{0}^{2 π} {F}_{sp} ( ω , {ϕ}_{0} ) * Y ( ω , ϕ ) d ω$$

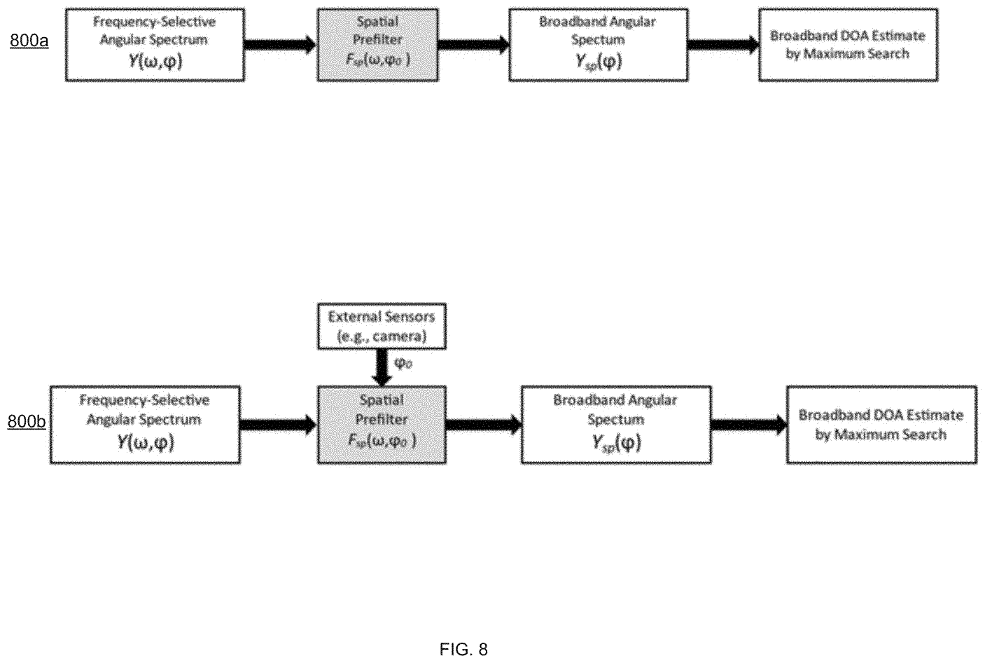

exhibits a stronger peak. As an example, the filter may be designed to suppress signals from the DOA of 75°. This may be true for some frequencies, while others may pass the filter (e.g., 1 kHz-4 kHz). Thereby, the spatial pre-filter may remove those frequencies from the spectral integration. As a result, the undesired masking may be reduced, and the sources present in the remaining frequencies may be localized better. For example, and referring at least to the example implementation of FIG. 8, an example block diagram of a broadband localizer 800a using a spatial pre-filter is shown.

In some implementations, the pre-filtering may be based upon, at least in part, Multichannel Coherent to Diffuse Ratio and in some implementations, the pre-filtering may be based upon, at least in part, beamformer output power for the first direction of arrival angle. For example, in some implementations, a source classification algorithm of ASL process 10 may hold the position of each detected source along with activity information and may update it in every frame. The previous state of this model may be provided to the core ASL algorithm of ASL process 10 in order to spectrally separate the incoming spectral ASL data, e.g., the data of user 46 and TV speaker 502). As one example technique to achieve this, a filter based on the multichannel Coherent-to-Diffuse-Ratio (MCDR) may be used as the spatial pre-filter. As a result, the core ASL may provide several localization results to the classifier. The known sources will no longer mask the new sources, and hence, it is expected that the WuW will be less likely to be missed even in the presence of a strong directional interferer. For example, the spatio-spectral pre-filter is a real valued function [0 1] of the DOA and may be based on the CDR. Generally, the CDR is the ratio of the power from the given DOA and the power of the diffuse sound. This filter ostensibly provides the information about whether the energy in one given frequency would rather belong to the considered DOA or to some other direction. Therefore, ASL process 10 may use this information as a metric to clean the input data from cross-talk of other sources (e.g., suppress those spectral parts of the signal that belong to sources with DOAs other than the steering angle of the pre-filter), in order to compute the update for the considered source.

In some implementations, a microphone array with more than two microphones may be used to send input from the first source and the second source to the pre-filter. For example, unlike typical CDR based filters that are only for microphone pairs, the MCDR based filter of the present disclosure may be derived for the general case of microphone arrays (with more than 2 microphones). This is notable, since a 2 microphone array generally cannot distinguish the front from the back (symmetry), meaning the typical CDR based filter also cannot. As such, a MCDR may be needed to make the concept work with general arrays. As a result, multiple raw DOA estimates may be obtained by ASL process 10, which may be fed into the classifier to assign the multiple raw DOA estimates to the already known sources and to update their statistics.

In some implementations, the design of the pre-filter may be strongly related to that of spatial post-filters known in the context of beamforming. Those may be usually employed in order to pronounce the spatial filtering obtained by a beamformer. In the case of spatial postfilters, it may be beneficial to correctly consider the beamformer gain, which has not always been the case in the history of spatial post-filter design. In particular, the historically first spatial post-filter described in R. Zelinski (A Microphone Array with Adaptive Post-Filtering for Noise Reduction in Reverberant Rooms. Proceedings IEEE International Conference on Acoustics Speech and Signal Processing (ICASSP). pages: 2578-2581, New York City, April 1988) did not account for the gain of the beamformer. It may be described as

$${H}_{Zel} = \frac{2}{M ( M - 1 )} {\sum }_{i = 0}^{M - 2} {\sum }_{l = i + 1}^{M - 1} Re \{ {J}_{{x}_{i} {x}_{l}} \}$$

in every frequency ω which is omitted for brevity. Here, Jₓ_{ᵢ}ₓ_{ⱼ} denotes the complex coherence function of the microphone signals and F. Notably, the dependency of the (real valued) filter on the complex coherence function of the microphone signals introduce the spatial characteristic of the filter. The “Zelinski-Filter” is based on the assumption of uncorrelated noise, which is typically not true in the lower frequencies. Therefore, the Zelinski-Filter may lose its spatial selectivity in the low frequencies. The design proposed by McCowan (I. A. McCowan, H. Boulard: Microphone Array Post-Filter for Diffuse Noise Field. In: Proceedings International Conference on Acoustics Speech and Signal Processing (ICASSP), Bd. 1, pp. 905-908, Orlando, Fla., May 2002) also did not account for the beamformer gain. This filter generally considers the noise as diffuse; leading to the following filter rule for each frequency w:

$${H}_{Mc} = \frac{2}{M ( M - 1 )} {\sum }_{i = 0}^{M - 2} {\sum }_{l = i + 1}^{M - 1} \frac{Re \{ {J}_{{x}_{i} {x}_{l}} - {J}_{{v}_{i} {v}_{l}} \}}{Re \{ 1 - {J}_{{v}_{i} {v}_{l}} \}}$$

where Jᵥ_{ᵢ}ᵥ_{ⱼ} is the coherence function of the diffuse noise. Using the diffuse noise model provides spatial selectivity in the lower frequencies. Both the Zelinski and the McCowan-Filter assume that the microphone signals are delay aligned for the desired steering angle φ₀ . Therefore, no dependency on the steering angle φ₀ is included in the equations. Furthermore, above equations hold for the case that all microphone signals have the same power spectral density. Otherwise a somewhat different estimation is used. A generalized form of the spatial postfilters may be described by T. Wolff, M. Buck: A Generalized View on Microphone Array Postfilters. Proceedings International Workshop on Acoustic Echo and Noise Control (IWAENC), Tel Aviv, Israel, 2010.

However, those filters are typically optimal if the beamformer gain was 1 (no gain or 0 dB) or if the beamformer was not there at all. This is the case in the application considered here (ASL): The pre-filter should be designed with respect to the microphone signals (as opposed to the beamformer output). Therefore, the filters described by Zelinski and McCowan are possible realizations of spatial pre-filters for the purpose of pre-filtering the input signals for ASL. Another possible realization would be the filter as proposed by Bitzer (J. Bitzer, K. U. Simmer, K D Kammeyer: Multi-Microphone Noise Reduction by Post-Filter and Superdirective Beamformer. In: Proceedings International Workshop on Acoustic Echo and Noise Control (IWAENC), pp. 100-103, Pocono Manor, Pa., Septiembre 1999), which only takes the ratio of the beamformer output power and the microphone power into account, whereas the beamformer must be steered into the desired angle φ₀. This kind of pre-filter may be considered useful since it may utilize a beamformer used within the SRP method. Accordingly, although the above-noted filters may be known, their usage as a spatial pre-filter for ASL is understood to be unique.

In some implementations, the generalized transfer function of spatial post-filters as described and noted above in Wolff may include a special case where the desired signal is the (coherent) signal from a given DOA and the undesired part is the diffuse sound at the microphones. This may be used to derive an estimate of the Coherent to Diffuse Ratio (CDR) in the direction of the given angle φ₀:

$$CDR ( {ϕ}_{0} ) = \frac{{\sum }_{i = 0}^{M - 2} {\sum }_{l = i + 1}^{M - 1} Re \{ {G}_{i} ( {ϕ}_{0} ) {G}_{l}^{*} ( {ϕ}_{0} ) ( {J}_{{x}_{i} {x}_{l}} - {J}_{{v}_{i} {v}_{l}} ) \}}{{\sum }_{i = 0}^{M - 2} {\sum }_{l = i + 1}^{M - 1} Re \{ 1 - {G}_{i} ( {ϕ}_{0} ) {G}_{l}^{*} ( {ϕ}_{0} ) {J}_{{x}_{i} {x}_{l}} \}}$$

The filters Gₘ(φ₀) denote the steering filters which compensate the delay for the m-th microphone with respect to the reference point (usually the array center) for the angle φ₀. The corresponding spatial filter may be, e.g.,

$${H}_{CDR} ( {ϕ}_{0} ) = \frac{CDR ( {ϕ}_{0} )}{1 + CDR ( {ϕ}_{0} )}$$

$${H}_{CDR} ( {ϕ}_{0} ) = \frac{{\sum }_{i = 0}^{M - 2} {\sum }_{l = i + 1}^{M - 1} Re \{ {G}_{i} ( {ϕ}_{0} ) {G}_{l}^{*} ( {ϕ}_{0} ) ( {J}_{{x}_{i} {x}_{l}} - {J}_{{v}_{i} {v}_{l}} ) \}}{{\sum }_{i = 0}^{M - 2} {\sum }_{l = i + 1}^{M - 1} Re \{ 1 - {G}_{i} ( {ϕ}_{0} ) {G}_{l}^{*} ( {ϕ}_{0} ) {J}_{{x}_{i} {x}_{l}} \}}$$

As compared to the filters proposed by McCowan, this filter may require only one division (efficient) and provide a less restrictive spatial characteristic (i.e., McCowan may be too selective). In the context of spatial pre-filtering for ASL, it may be desired to use a filter that is not too restrictive.

In some implementations, ASL process 10 may exclude 304 sound from an a-priori known steering angle of the spatial pre-filter from a localization of one of the first source and the second source. For instance, and referring at least to the example implementation of FIG. 8, an example block diagram for a broadband localizer 800b is shown where the pre-filter steering angle is determined by a-priori knowledge and/or information from external sensors. In some implementations, the principle of the present disclosure may define the steering angle of the pre-filter a-priori. For this to make sense, a-priori knowledge is generally required, which may, for instance, be available by means of a camera or other kinds of sensors. It may also be known a-priori that in a given localization task an interfering (sound) source is present at a certain DOA. Then, the spatial pre-filter may be configured to always suppress sounds from this DOA in the spectral integration. Generally, this implementation may uses a given angle to compute the filter that maintains signals from the given angle while suppressing signals from elsewhere. In some implementations, an MCDR filter may be used, as well as known filters, such as Zelinski, McCowan, or others. In some implementations, ASL process 10 may update the localization with respect to signals from the given angle.

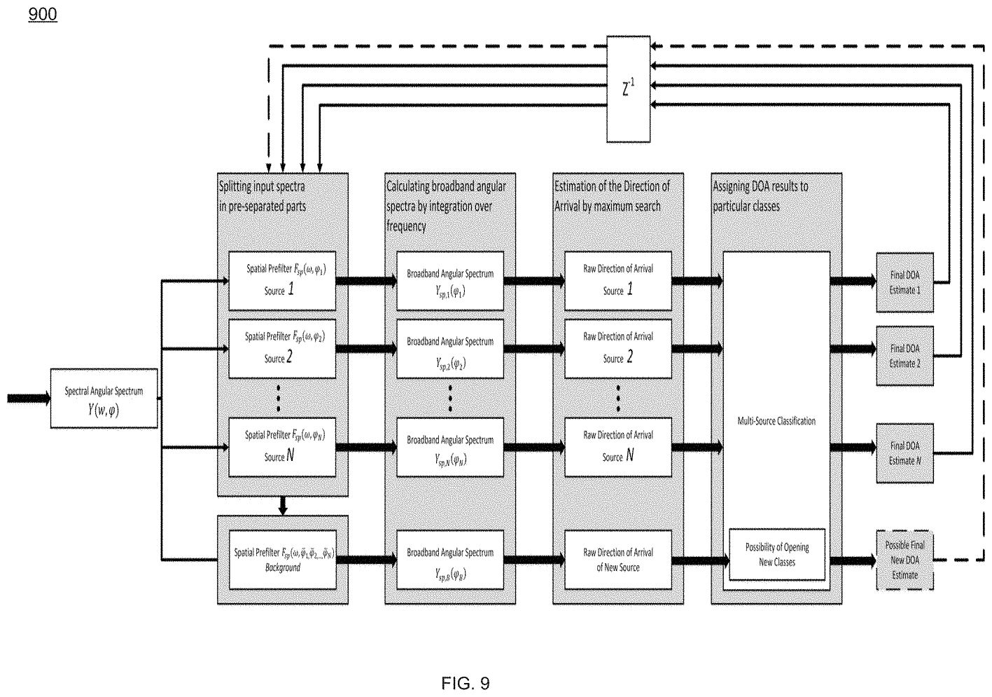

In some implementations, ASL process 10 may determine 306 a steering angle of the spatial pre-filter based upon, at least in part, a localization result from a last processing frame. For instance, and referring at least to the example implementation of FIG. 9, a generic structure 900 of a pre-filtering approach for source localization in combination with multi-source classification as a postprocessor that may be used by ASL process 10 is shown. As will be discussed below, ASL process 10 may use the ASL results from the last frame to determine the pre-filter steering angles, compute a pre-filter for each known source, generate a broadband angular spectrum for each source, generate a broadband angular spectrum for those frequencies that are not covered by any of the known sources (the rest), find the angle that maximizes each angular spectrum (raw DOA result for current frame), and provide several raw DOA results to a classifier. For example, in some implementations, ASL process 10 may estimate, in a first frame, a first direction of arrival angle for the first source and may estimate a second direction of arrival angle for the second source simultaneously, may pre-filter, in a second frame, any frequency may be pre-filtered for the first source that does not contain energy from the first direction of arrival angle of the first source in the first frame, and may pre-filter, in the second frame, any frequency for the second source that does not contain energy from the second direction of arrival angle of the second source in the first frame. For example, ASL process 10 may exploit the results from the past classification output (for example, this is in the form of 3 sources currently known, and for each of which there is activity information per time frame along with the DOA estimates). Assume for example purposes only that all ASL process 10 wants to do from one time frame to the next (e.g., in 10-20 ms steps) is to change the DOA estimate, e.g., 1-5 degrees compared to the previous frame (since sources do not move too fast). For instance, if a source cycles once around the device it has for example 360° in 10 seconds, there is 36°/second, and therefore ˜0.36° per frame (100 frames per second). So, 5° per frame is already fast. As a result, ASL process 10 may use the DOA estimate from the past frame and compute a spatio-spectral filter on the microphone data that suppresses any frequency that does not contain energy from the DOA of the last frame. This may yield a spectrum that ideally contains only information about the source to which this pre-filter has been steered. In some implementations, such spatio-spectral filtering is applied to any known source, not just the source of interest, since it may be better to localize not just the source of interest, but also the interferers. For example, for ASL, it is generally not clear what is interference and what is desired. Here, the goal may be only to localize any source as well as possible, including the interferes. Additionally, a spectrum which contains the rest may also be provided that may drive the detection of new sources.

In some implementations, the spatial width of the pre-filter may be between 15° and 30° depending on frequency, so a source may have to move further than that per 10-20 ms, which is assumed does not happen. Therefore, ASL process 10 may use the DOA from the last frame and may be sure that the source is still captured by its pre-filter. It will be appreciated that the spatial width of the pre-filter may vary without departing from the scope of the present disclosure. As such, the description of the spatial width of the pre-filter being between 15° and 30° should be taken as example only and not to otherwise limit the scope of the present disclosure.

As noted above, spatial pre-filters may also be used by ASL process 10 with changing steering angles at runtime. For instance, ASL process 10 may use the pre-filtering approach in combination with a multisource localization system as described above (e.g., consisting of a core localizer and a postprocessor in the form of a classifier). Given the considered system is in principle capable of localizing multiple sources, the masking effects may be reduced by introducing a pre-filtering stage. Here, the steering angles of the pre-filters may be chosen based on the latest result(s) from the last processing frame. Hence, each of the sources known so far may get a dedicated pre-filter, which may let only the DOA from the last frame pass. Signal components from any other angle may be suppressed. Generic structure 900 shows this concept. Note that still only one spectral angular spectrum Y(ω, φ) has to be computed by ASL process 10. In some implementations, ASL process 10 may determine 308 a further spatial pre-filter associated with background to reduce masking artifacts and enable localization of one or more previously masked sources. For instance, a bank of pre-filters may split the incoming data into N spatially pre-separated parts. The integration afterwards may lead to the individual angular spectra. A Maximum search on each one of them may provide the corresponding raw DOA estimates for each source. Additionally, an extra angular spectrum may be created for those frequencies that are not covered by the known source. This angular spectrum may be used to detect new sources.

In some implementations, the pre-filter bank for the known sources may have a similar effect as the E-step in the EM-Algorithm: e.g., it may interpret the incoming data spatially and assigns certain frequencies to the sources so ideally independent angular spectra may be obtained that do no longer suffer from masking. At the same time, the maximum search may be performed on broadband angular spectra, hence the robustness with respect to aliasing may be maintained.

Since each pre-filter may carry the meaning of a spectral E-step, the pre-filter should not be too restrictive (spatially). The higher the spatial selectivity of the pre-filter, the higher the risk of wrong frequency-to-source assignments. Using the MCDR-based filter, as described above, it has been shown that this has a suitable spatial selectivity (˜30° beamwidth for common microphone array sizes). Since this is true, the idea of the recursive implementation enables an improved detection of masked sources in a stand-alone online localization system (without relying on a-priori information).

In some implementations, the present disclosure may be implemented using only a single pre-filter (e.g., an MCDR based pre-filter). In this example, only one steering angle has to be determined at runtime and only one spatial pre-filter has to be steered at runtime. The steering angle of this filter may be found by selecting one of the known sources. The selection may be based on the properties of that source (e.g., based on a decision which of the sources detected so far appears “interesting”). A possible choice may be to use the angle of the source that shows the least movement along with the highest activity measured over a certain time period, as well as other factors. The selection decision may be somewhat arbitrary (e.g., in principle, any source may be selected). In the example, two angular spectra may be generated (e.g., one for the spectrum belonging to the “interesting” source, and the second for the remaining source). In some implementations, both angular spectra may deliver raw DOA results after maximum search, and both raw DOA estimates for the current frame may be passed to the classifier.

In some implementations, the present disclosure may be implemented using binary masks instead of real-valued filter weights. This way, divisions needed during pre-filter computation may be avoided.

As such, (1) ASL process 10 may select a source that shows a lot of activity while not moving much. The estimated DOA of that source may be chosen as the pre-filter steering angle (DOA from last frame). (2) The pre-filter may be steered towards that angle. (3) The pre-filter may be applied to the current incoming signals resulting in a spectral mask that may be 1 if the respective frequency is dominated by a signal from the steering direction. The mask may be zero otherwise. (4) Y(ω, φ) may be computed. (5) The mask may be applied to Y(ω, φ) and the integration along frequency may be carried out. As a result, the angular spectrum for the pre-filter DOA may be obtained. (6) The inverse mask may be applied to Y(ω, φ) and the integration along frequency may be carried out again. This sums up all those spectral parts that have not been summed up in the previous step. As a result, the second angular spectrum may be obtained. (7) Maximum search for both angular spectra may yield the two corresponding raw DOA estimates. (8) The raw DOA data may be passed to the classifier as usual to obtain the final DOA estimates.

In the standard situation where there is a dominant interfering source, such as a kitchen radio for example, ASL process 10 may find the radio that keeps playing and also does not move much. ASL process 10 may find only this source and steer the pre-filter towards its DOA estimate (all this may be possible without the need for a pre-filter). Now, the pre-filter may be active and may check in every frame which frequencies belong to the radio. Any other spectral parts may be filtered out and analyzed in their own angular spectrum. Thus, if now some utterance is spoke from a DOA other than the radio, the pre-filter may not assign the respective frequency bins to the radio source but to the rest. Therefore, everything but the radio may be localized while the radio is playing without having the radio mask the utterance.

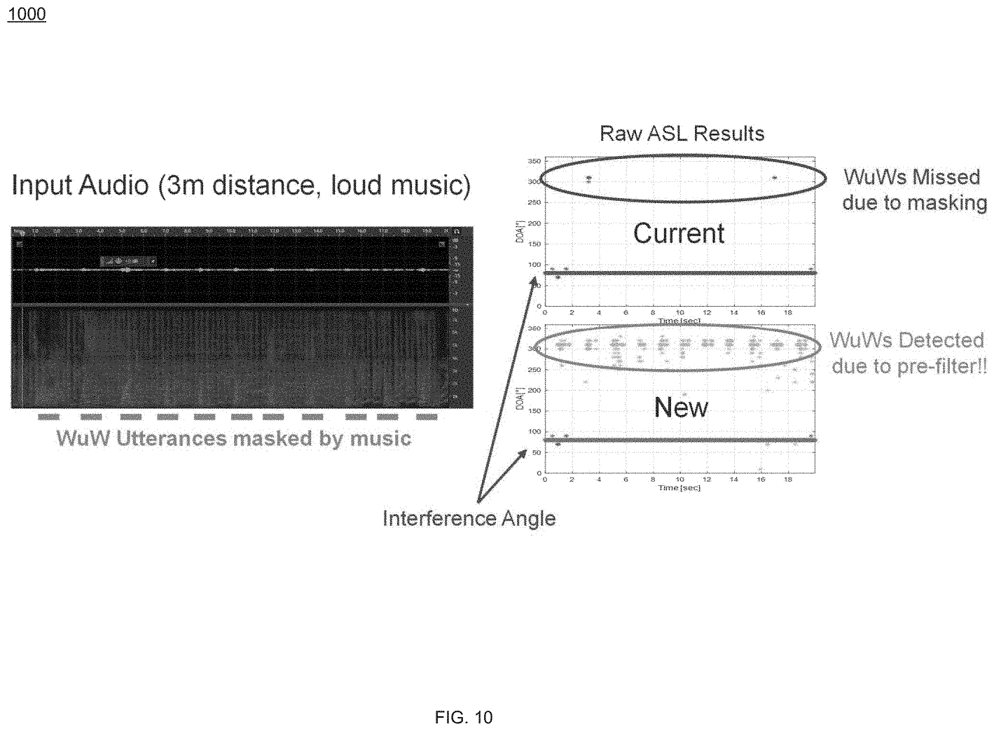

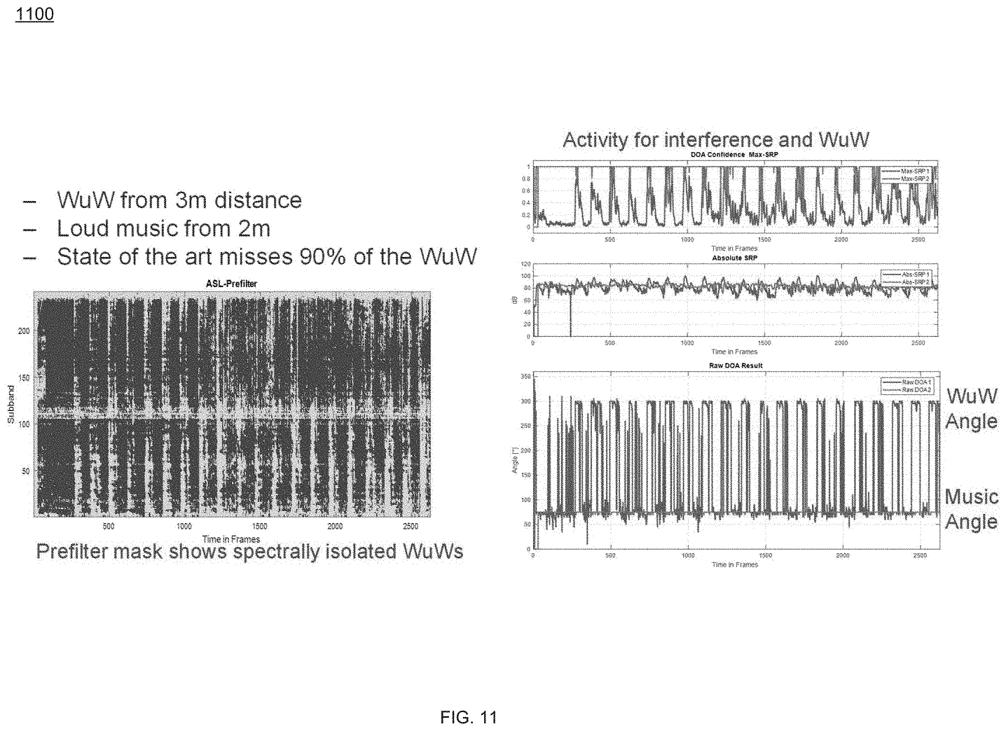

As a non-limiting example, and referring at least to the example charts 1000 and 1100 shown FIG. 10 and FIG. 11 respectively, assume that there is a loudspeaker (e.g., TV speaker 702) in a distance of 2 meters from the microphone array (e.g., located within smart speaker 706) and user 46 speaks the WuW from 3 meters distance but from another angle than the angle of TV speaker 702. Further assume that the loudspeaker plays music permanently and therefore interferes strongly with the WuW, as both have similar energy leading to a signal-to-noise (SNR) ratio of ˜0 dB at the microphones. In the example, ASL process 10 may localize the music relatively immediately, as it is very directional and does not move. ASL process 10 may compute the pre-filter that lets sound from the direction of the loudspeaker (the music) pass. ASL process 10 may apply this filter in every subsequent frame. As long as the music is active in all frequencies, the filter may allow all frequencies to pass, and the DOA updates for the loudspeaker may be computed as usual by ASL process 10.

Referring still to FIG. 1000, on the left, there is shown a spectrogram of a microphone signal containing music from a loudspeaker as well as several speech utterances. On the right, there is shown the raw DOA estimates using known filtering systems. This shows that the music at 90° is seen, but almost nothing is detected regarding the speech utterance (e.g., WuW). Right bottom shows an ASL with the spatial pre-filter of the present disclosure, where now the WuW speech does get detected.

Referring still to FIG. 1100, on left, there is shown an example for a binary pre-filter mask. On part of the graph indicates the spectral regions where the music is present (e.g., steering angle of the spatial pre-filter). The other part of the graph indicates the presence of energy from elsewhere. On the right bottom, there is shown two raw DOA results (before the postprocessing). One part is the music source, and the other part is the speech. As can be seen, there are many more raw DOAs for the speech, even though the music is present.

In some implementations, ASL process 10 may combine 310 the spatial pre-filter with one or more non-spatial filters. For instance, and continuing with the example, at the same time, a complementary filter may also be applied to the input data, where up to now, this complementary filter will mostly be zero. When the WuW appears (e.g., assuming for example purposes only that it is present from 1-3 kHz), the pre-filter for the loudspeaker will become zero in this frequency band, while the complementary filter becomes one in the same range to let the WuW pass. This happens, e.g., because in these frequencies, the input signals cannot be explained with energy from the DOA of the loudspeaker. The loudspeaker localization is therefore protected from the WuW and vice versa.

While the present disclosure is described with us of the WuW detection, it will be appreciated that the present disclosure may be used with various other ASR uses. As such, the use of WuW detection should be taken as example only and not to otherwise limit the scope of the present disclosure.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
identifying, by a computing device, a plurality of sources, wherein a first source of the plurality of sources is a source of interest and wherein a second source of the plurality of sources is an interference source; and
monitoring the first source and the second source simultaneously by implementing a spatial pre-filter for acoustic source localization.

2. The computer-implemented method of claim 1 wherein the pre-filtering is based upon, at least in part, Multichannel Coherent to Diffuse Ratio.

3. The computer-implemented method of claim 1 further comprising excluding sound from an a-priori known steering angle of the spatial pre-filter from a localization of one of the first source and the second source.

4. The computer-implemented method of claim 1 wherein a steering angle of the spatial pre-filter is determined based upon, at least in part, one of a-priori knowledge and an external sensor.

5. The computer-implemented method of claim 1, further comprising determining a steering angle of the spatial pre-filter based upon, at least in part, a localization result from a last processing frame.

6. The computer-implemented method of claim 5 wherein each detected source of the plurality of sources has a dedicated spatial pre-filter of a bank of spatial pre-filters.

7. The computer-implemented method of claim 6 further comprising determining a further spatial pre-filter associated with background to reduce masking artifacts and enable localization of one or more previously masked sources.

8. The computer-implemented method of claim 5 wherein an expectation step is carried out in a postprocessor using one or more broadband raw acoustic source localization results.

9. The computer-implemented method of claim 5 wherein spatial pre-filtering is used as a replacement for an expectation step in an expectation maximization based classifier.

10. The computer-implemented method of claim 1 further comprising combining the spatial pre-filter with one or more non-spatial filters.

11. A computing system including one or more processors and one or more memories configured to perform operations comprising:
identifying, by a computing device, a plurality of sources, wherein a first source of the plurality of sources is a source of interest and wherein a second source of the plurality of sources is an interference source; and
monitoring the first source and the second source simultaneously by implementing a spatial pre-filter for acoustic source localization.

12. The computing system of claim 11 wherein the pre-filtering is based upon, at least in part, Multichannel Coherent to Diffuse Ratio.

13. The computing system of claim 11 further comprising excluding sound from an a-priori known steering angle of the spatial pre-filter from a localization of one of the first source and the second source.

14. The computing system of claim 11 wherein a steering angle of the spatial pre-filter is determined based upon, at least in part, one of a-priori knowledge and an external sensor.

15. The computing system of claim 11, further comprising determining a steering angle of the spatial pre-filter based upon, at least in part, a localization result from a last processing frame.

16. The computing system of claim 15 wherein each detected source of the plurality of sources has a dedicated spatial pre-filter of a bank of spatial pre-filters.

17. The computing system of claim 16 further comprising determining a further spatial pre-filter associated with background to reduce masking artifacts and enable localization of one or more previously masked sources.

18. The computing system of claim 15 wherein an expectation step is carried out in a postprocessor using one or more broadband raw acoustic source localization results.

19. The computing system of claim 15 wherein spatial pre-filtering is used as a replacement for an expectation step in an expectation maximization based classifier.

20. The computing system of claim 11 further comprising combining the spatial pre-filter with one or more non-spatial filters.
